(19) United States
(12) Patent Application Publication
(10) Pub. No.: US 2005/0220261 A1
(43) Pub. Date: Oct. 6, 2005

(54) Fuel assembly for a boiling water reactor

(75) Inventors: Dieter Kreuter, Rodermark (DE); Peter Rau, Leutenbach (DE); Reinhart Zimmermann, Uttenreuth (DE); Dieter Bender, Kleinseebach (DE); Walter Uebelhack, Erlangen (DE); Werner Meier, Kunreuth (DE)

Correspondence Address: LERNER AND GREENBERG, PA, P O BOX 2480, HOLLYWOOD, FL, 33022-2480, US

(73) Assignee: Framatome ANP GmbH

(21) Appl. No.: 10/914,913

(22) Filed: Aug. 9, 2004

Related U.S. Application Data
(63) Continuation of application No. PCT/EP03/00708, filed on Jan. 24, 2003.

(30) Foreign Application Priority Data
Feb. 8, 2002 (DE) 102 05 202.6

(51) Int. Cl. G21C 3/32

(52) U.S. Cl. 376/443

(57) ABSTRACT

A fuel assembly for a boiling water reactor has a plurality of fuel rods which are mounted in a plurality of spacers disposed at a spacing distance from each other in the axial direction of the fuel element. At least one of the fuel rods has a reduced length. Deflection elements are arranged at least in the upper region of the fuel element in order to improve the dry-out behavior of the assembly. The fuel assembly further includes measures that reduce a loss of pressure caused in the upper region by the deflecting elements so as to improve thermo-hydraulic stability and the shutdown behavior.

### CROSS-REFERENCE TO RELATED APPLICATION

This application is a continuation, under 35 U.S.C. § 120, of copending international application No. PCT/EP03/00708, filed Jan. 24, 2003, which designated the United States; this application also claims the priority, under 35 U.S.C. § 119, of German patent application No. 102 05 202.6, filed Feb. 8, 2002; the prior applications are herewith incorporated by reference in their entirety.

### BACKGROUND OF THE INVENTION

### Field of the Invention

The invention relates to a fuel assembly for a boiling water reactor, which includes a number of part-length fuel rods.

It is known from U.S. Pat. No. 5,112,570 to design some of the fuel rods of a fuel assembly for a boiling water reactor to be shorter than the other fuel rods, so that empty positions are formed in the upper region in the fuel rod grid. These measures serve on the one hand to improve the shutdown performance and on the other hand to reduce the inclination toward thermohydraulic instability. The improved shutdown performance brought about by the use of part-length fuel rods is a consequence of the increase in the moderator/fuel ratio in the upper region of the fuel assembly, which ensures that the reactor can be kept subcritical even in the cold state. Furthermore, the empty positions in the upper region of the fuel assembly reduce the flow resistance, so that the pressure drop in the two-phase region and therefore the tendency toward thermo-hydraulic instability are reduced.

Japanese published patent application JP 11311688 A describes a fuel assembly which likewise has part-length fuel rods in order to reduce the pressure drop in the two-phase region. To further reduce the pressure drop, there is provision for spacers to be used in this fuel assembly, above the part-length fuel rods, which spacers do not have grid cells at these empty positions, where instead of grid cells they contain only supporting elements for connecting adjacent grid cells to one another.

As an alternative to the use of part-length fuel rods, there is provision, in a fuel assembly described in international PCT publication WO 99/17299, to arrange spacers in the lower region of the fuel assembly at a distance from one another which is less than the distance between the spacers in the upper region.

A further problem in designing fuel assemblies for a boiling water reactor, moreover, is that these elements are at the maximum possible distance from the boiling transition power. In this context, the boiling transition power is the power at which the film of water which is present on the fuel rod evaporates, leading to a significant deterioration in the heat transfer (dry out). If the boiling transition power is exceeded, a film or layer of steam, which represents a resistance to heat transfer, is formed at the surface of fuel rods which are present in the fuel assembly. Since the heat quantity generated in the fuel rod is then temporarily no longer completely dissipated, the temperature of the fuel rod rises until a new thermal equilibrium is established. This can lead to overheating of the fuel rod and therefore also to thermal overloading of a fuel rod cladding tube. Overheating of this nature must be avoided at all costs, since it would lead to a shortening of the service life of the fuel rod and therefore of the fuel assembly.

European patent EP 0 786 781 B1 describes a fuel assembly with part-length fuel rods, in which flow-throttling elements are disposed in the lower region of the fuel assembly, in the region of the part-length fuel rods, in order to produce an improved thermohydraulic stability by means of the higher pressure drop which is thereby generated in the lower region of the fuel assembly, without an associated deterioration in the dry-out behavior. In this case, a deterioration in the dry-out behavior is avoided, despite the throttling in the lower region, by virtue of the fact that this throttling takes place in the region of the part-length fuel rods, for which there is a lower risk of drying out. However, the risk of the long fuel rods drying out cannot be reliably avoided by a measure of this type.

To improve the dry-out behavior it has become known from U.S. Pat. No. 5,229,068 to arrange diverter elements, for example swirling lugs arranged at the spacers, in the fuel assembly. The diverter elements impart a horizontal velocity component to the water, which is heavier than the steam, so that in the two-phase region better wetting of the fuel rods with water is achieved. This measure makes it possible to increase the boiling transition power.

If diverter elements of this type are disposed in the upper region of the fuel assembly, their higher flow resistance increases the pressure loss in the upper region of the fuel assembly, so that the reduction in the pressure loss brought about by the part-length fuel rods is at least partially compensated for again, and the tendency toward thermohydraulic instability is increased.

### SUMMARY OF THE INVENTION

It is accordingly an object of the invention to provide a fuel assembly for a boiling water reactor which overcomes the above-mentioned disadvantages of the heretofore-known devices and methods of this general type and which provides for a fuel assembly that is improved both in terms of its dry-out behavior and in terms of its thermohydraulic properties.

With the foregoing and other objects in view there is provided, in accordance with the invention, a fuel assembly for a boiling water reactor, comprising:
a plurality of spacers spaced apart from one another and disposed along an axial direction of the fuel assembly;
a plurality of fuel rods mounted in said spacers, said fuel rods including at least one part-length fuel rod;
diverter elements disposed at least in an upper region of the fuel assembly; and
means for reducing a pressure loss caused by said diverter elements in the upper region.

In other words, the objects of the invention are achieved with a fuel assembly for a boiling water reactor, in which a plurality of fuel rods are mounted in a plurality of spacers that are spaced apart from one another in the axial direction of the fuel assembly, of which at least one fuel rod is a part-length fuel rod, and which is provided with diverter elements arranged at least in the upper region of the fuel assembly, has means for reducing the pressure loss caused by the diverter elements in this region.

The invention is based on the discovery that, contrary to the restoration of a pressure drop as desired in U.S. Pat. No. 5,229,068, in the upper region, it is rather advantageous for the pressure drop still to be kept as low as possible, in order to avoid thermohydraulic instability. In other words, measures are provided to reduce or compensate for the increase in the flow resistance generated by the diverter elements in the upper region by using suitable flow-dynamic measures.

In this text, the terms “upper region” and “lower region” are to be understood as meaning that the fuel assembly is imaginarily divided along its axial extent into two subregions which adjoin one another. The “upper region” may, but does not have to, coincide with the two-phase region, i.e. the boundary between the upper and lower regions does not necessarily coincide with the two-phase boundary, and the “upper region” may be smaller or larger than the two-phase region.

In accordance with one preferred configuration of the invention, the reduction in the pressure loss is achieved by virtue of at least one of the spacers arranged in the upper region having a reduced pressure loss. In one advantageous configuration, this can be realized by virtue of the fact that spacers made from a nickel-based alloy, the web thickness of which is considerably less than the web thickness of the spacers made from a zirconium alloy that are customarily used, are employed in the upper region of the fuel assembly, preferably in the region above the part-length rods. Moreover, this construction means that the axial region of good moderation is not adversely affected in terms of its neutron economy by the use of spacers made from a zirconium alloy. This measure is based on the consideration that the use of spacers made from a nickel-based alloy, despite the inherently less suitable corrosion properties, is not critical in the upper region of the fuel assembly, since the shadow corrosion, which is the main factor in determining the corrosion performance, occurs mainly in the lower region of the fuel assembly.

In a further advantageous configuration of the invention, in addition, or as an alternative to the foregoing measure, it is also possible for the flow resistance of the diverter elements arranged in the upper region of the fuel assembly to be reduced in the upward direction. This can be realized on the one hand by reducing the number of diverter elements or alternatively by reducing the surface area projected onto a plane perpendicular to the axial direction (active surface area). In this case, it is in principle even possible for the uppermost spacer to be designed without any diverter elements.

This measure is based on the consideration that the pressure drop in the upper region of the fuel assembly increases exponentially in the upward direction, and consequently, measures for reducing the pressure drop are expedient in particular in the uppermost region of the fuel assembly. In other words, it has proven particularly expedient to reduce the flow resistance within the fuel assembly to a greater extent in the uppermost zone of the upper region than in the lower zone of the upper region.

Other features which are considered as characteristic for the invention are set forth in the appended claims.

Although the invention is illustrated and described herein as embodied in a fuel assembly for a boiling water reactor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a diagrammatic, side view outline illustration of a fuel assembly according to the invention;

FIG. 2 is a partial view of a spacer with square meshes for receiving fuel rods, as used in a lower region of the fuel assembly;

FIG. 3 is a partial view of a spacer with round meshes for receiving fuel rods, as used in a lower region of the fuel assembly;

FIG. 4 is a partial view of a spacer in a lower section of the upper region of the fuel assembly;

FIG. 5 is a partial view of a spacer disposed above the spacer of FIG. 4;

FIGS. 6 to 8 illustrate alternative configurations of a spacer in the upper region of the fuel assembly.

### DESCRIPTION OF THE PREFERRED EMBODIMENTS

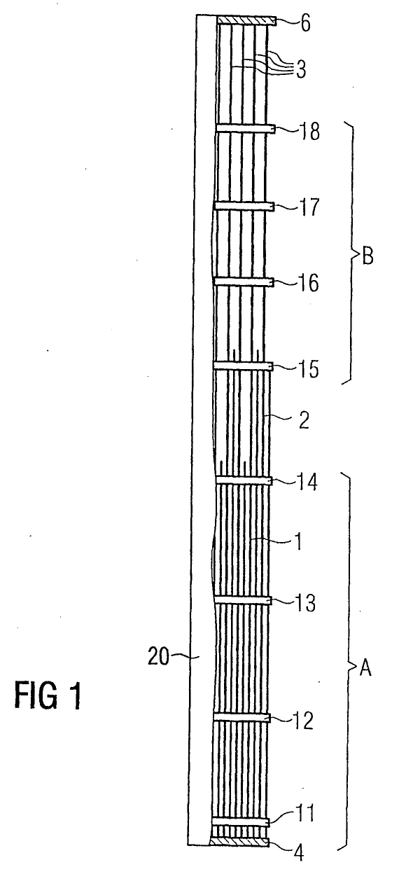

Referring now to the figures of the drawing in detail and first, particularly, to FIG. 1 thereof, a fuel assembly includes a multiplicity (a bundle) of fuel rods 1 to 3, which in the operating state extend vertically between a lower rod-holding plate 4 and an upper rod-holding plate 6. The fuel rods 1 to 3 are arranged parallel to one another and are clamped into spacers 11 to 18. The fuel rods 1 and 2 are part-length fuel rods and they are shorter than the full length fuel rods 3, which extend over the entire length of the fuel assembly. It can be seen from the figure that the part-length fuel rods 1 are shorter than the part-length fuel rods 2. Whereas the fuel rods 3 of normal length do not rest on the lower rod-holding plate 4, or do so only loosely, the lower end of the part-length fuel rods 1, 2 is in each case securely anchored in the rod-holding plate 4.

A fuel assembly channel 20 which is open at the top and bottom surrounds the bundle of fuel rods 1 to 3 and forms a closed passage for a liquid coolant which enters through the lower rod-holding plate 4. The coolant—preferably water—is heated by the fuel rods 1 to 3 as it passes through the fuel assembly channel 20 and starts to evaporate, so that a mixture of coolant in liquid phase and in vapor phase is present in the upper region of the fuel assembly.

The installation of part-length fuel rods 1, 2 means that the clear passage cross section is larger in the upper region of the fuel assembly than in the lower region, thereby counteracting the higher flow velocity which occurs in the two-phase region.

In design terms, the spacers 11 to 18 are divided into a lower group A (11 to 14) and an upper group (15 to 18), with the distances between the spacers, at least in group A, being identical. In group B, the distances between the spacers 15 to 18 may also be shorter. The increase in the pressure loss caused by a reduction in the distances between the spacers 15 to 18 can be compensated for by using a greater number of part-length fuel rods 1, 2. The boundary between the lower group A and the upper group B may, but does not have to, coincide with the two-phase boundary or the end of the shortest part-length fuel rods 1.

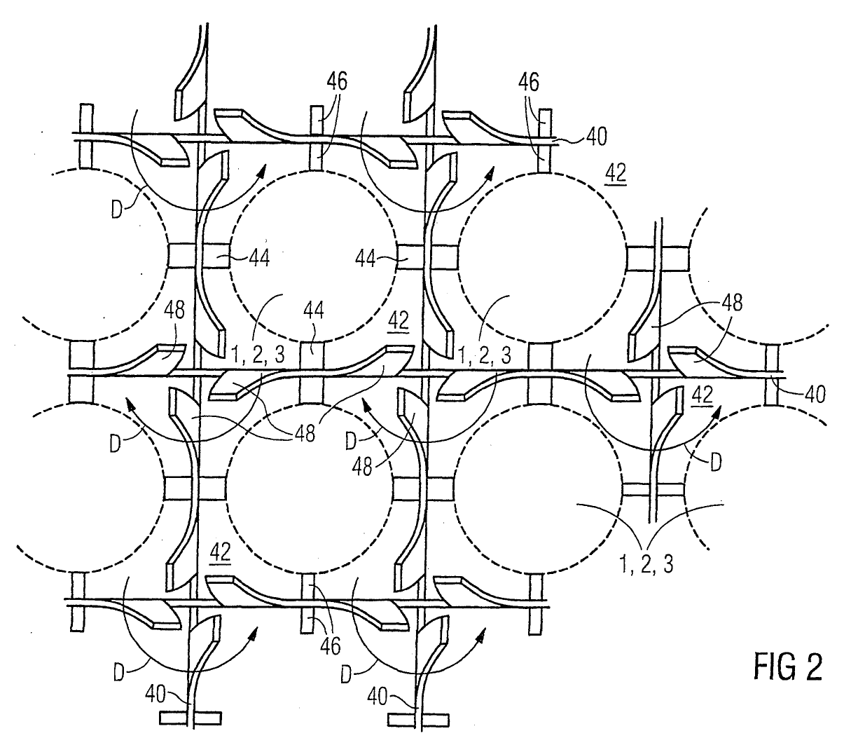

FIG. 2 shows, on a greatly enlarged scale, one of the spacers from group A (11 to 14) or the lowermost of the upper spacers 16 from group B. The spacer is composed of webs 40 which cross one another at right angles and also penetrate through one another. The webs 40 form approximately square meshes 42 for receiving the fuel rods 1 to 3, which are clamped securely in the meshes 42 by means of bosses 44 and springs 46. Diverter elements 48, which in the exemplary embodiment shown in the Fig. are swirling lugs bent off laterally, are arranged at the webs 40 of the spacer. The swirling lugs are arranged at the crossing points, in such a manner that coolant flowing in the axial direction (parallel to the fuel rods) through the spacers between the fuel rods is diverted and acquires a (horizontal) velocity component oriented perpendicular to the axial direction, in the exemplary embodiment which is specifically illustrated, a swirling momentum D. The rotary motion produced by the swirling lugs generates a centrifugal acceleration which throws the liquid phase of the coolant onto the fuel rods 1 to 3, thereby boosting the cooling thereof and reducing the risk of film detachment accordingly.

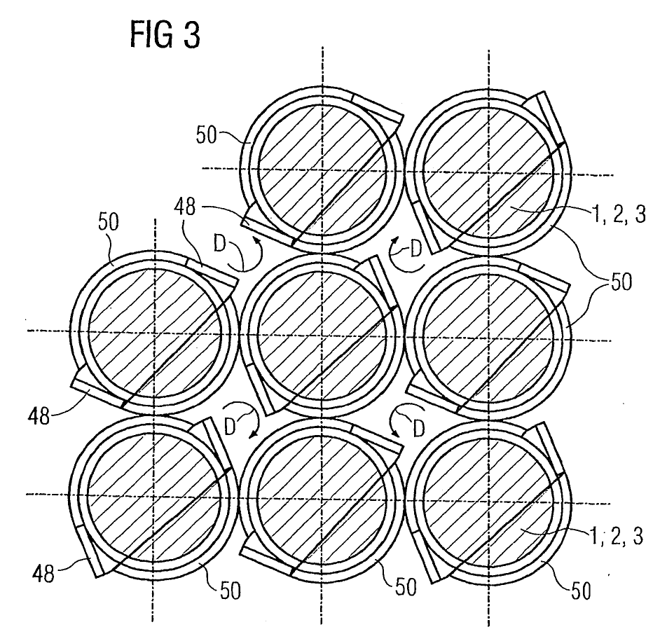

A spacer as shown in FIG. 3, in which the meshes provided for receiving the fuel rods 1 to 3 are formed by hollow-cylindrical sleeves 50 which likewise bear swirling lugs bent off laterally as diverter elements 48 and impart a swirling momentum to the coolant flowing past, acts in the same way.

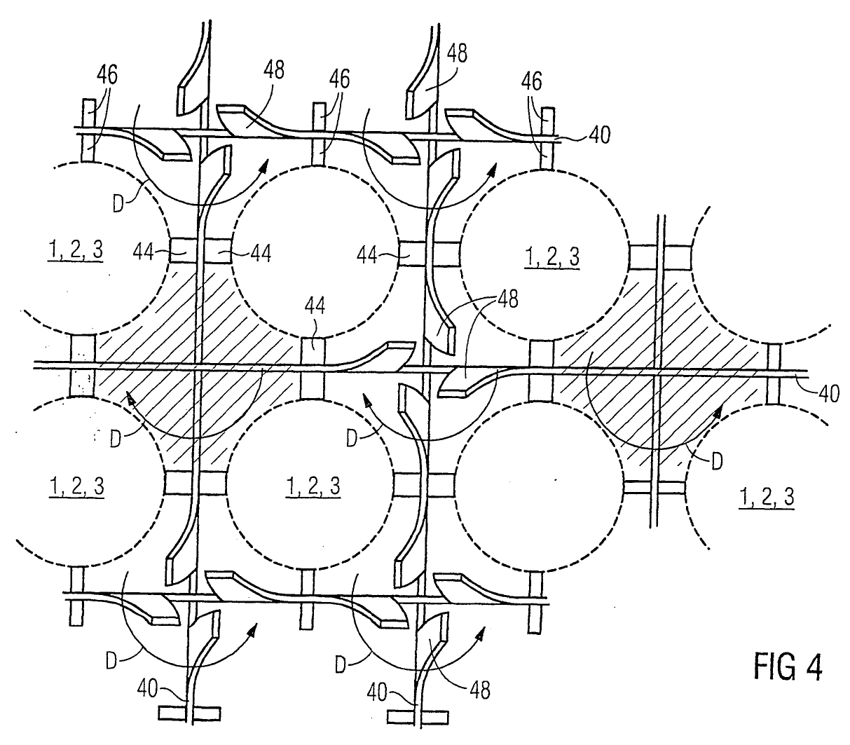

FIG. 4 shows a spacer from group B, which is arranged above the spacer shown in FIG. 2. It can be seen from the figure that some of the crossing points (indicated by hatching in the figure) do not have any diverter elements 48. In the example shown in the figure, there is provision for one of four crossing points to be designed without diverter elements.

Suitable crossing points are in particular the crossing points at the corners of meshes which are located above the free end of part-length fuel rods.

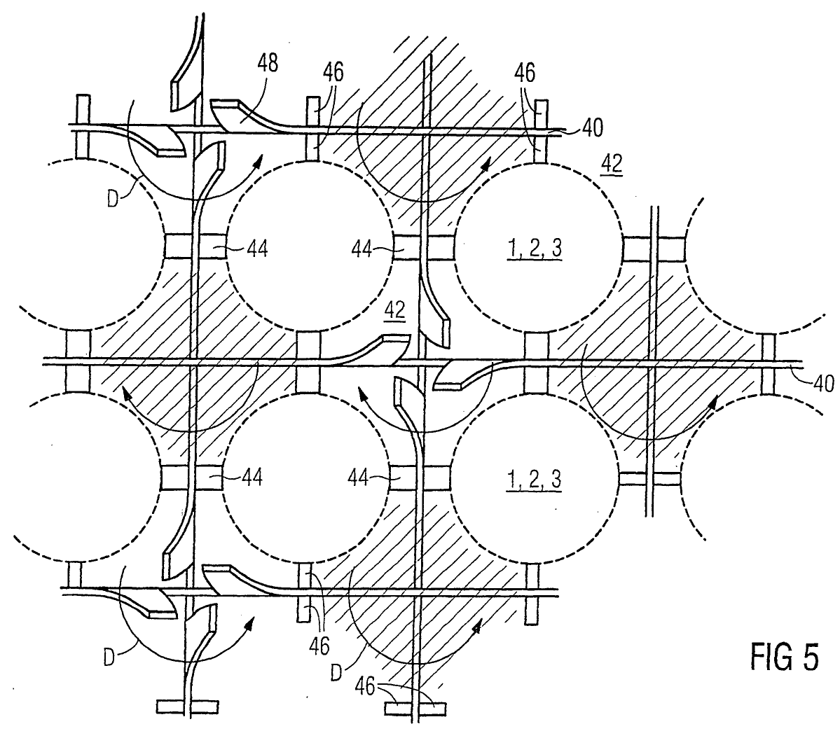

FIG. 5 shows a spacer which is arranged above the spacer shown in FIG. 4 and in which every second crossing point is devoid of diverter elements 48.

The number of diverter elements is reduced accordingly up to the uppermost spacer 18, which may in principle even be devoid of diverter elements.

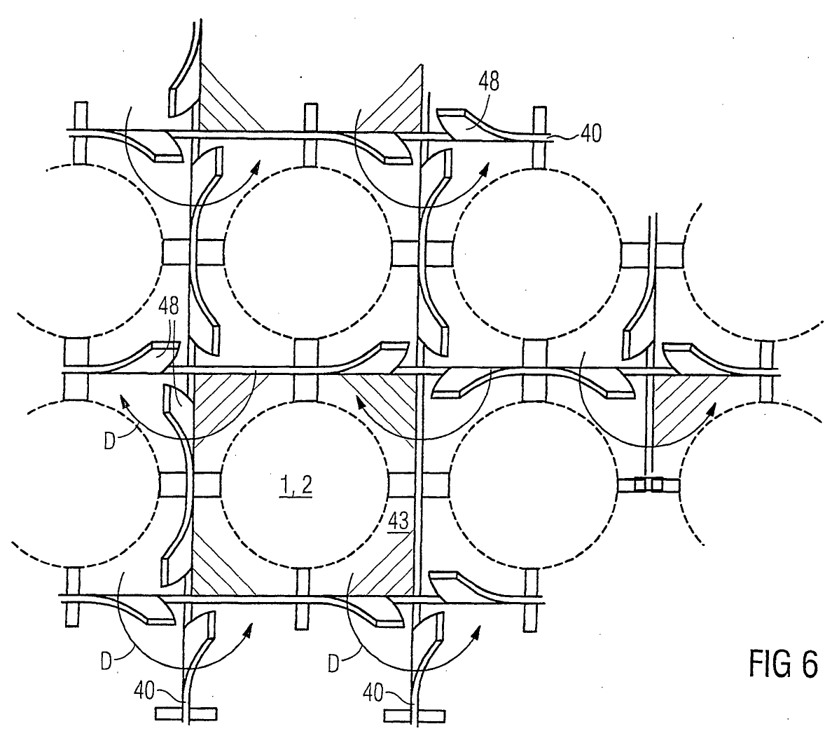

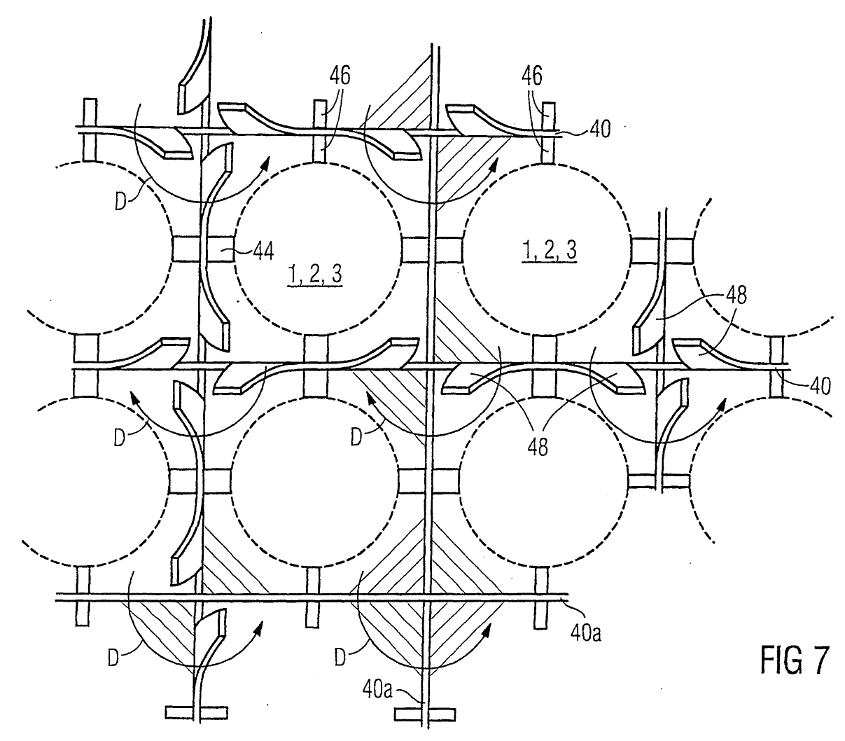

Further alternative configurations are illustrated in FIGS. 6 and 7, in which the number of diverter elements per crossing point has been reduced (missing diverter elements (regions devoid of diverter elements) indicated by hatching, FIG. 6) or in which webs 40a (FIG. 7) which do not have any bent-off swirling lugs are used. In this embodiment, too, in particular the swirling lugs which would generate a cross-flow of coolant directed into the interior of a mesh which does not have a fuel rod passing through it, i.e. is located above the end of a part-length rod, are eliminated. In the exemplary embodiment shown in FIG. 6, it can be seen that a mesh 43 is completely devoid of diverter elements facing into its interior. Meshes 43 without diverter elements of this nature preferably form empty positions, i.e. are located above the end of part-length fuel rods 1, 2 in the mesh positions taken up by these rods.

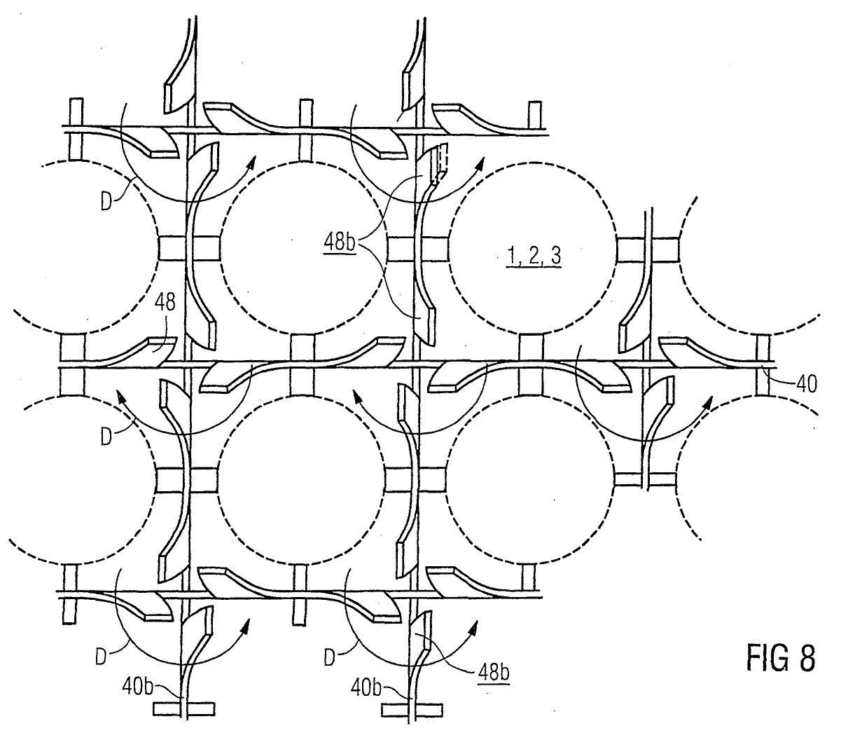

In a further alternative configuration, shown in FIG. 8, there is provision for some of the diverter elements 48, in the exemplary embodiment the swirling lugs 48b formed integrally on the web 40b, either to be made shorter or to be bent over to a lesser extent, so that their flow-diverting action and therefore also their flow resistance is reduced. In this embodiment, the sum of the projected surface areas of all the diverter elements 48, 48b of an upper spacer is smaller than the sum of the projected surface areas of all the diverter elements 48, 48b of an upper spacer arranged below it.

In addition, or as an alternative to the measures which have been explained with reference to FIG. 2 to 8, at least the uppermost spacer or the upper spacers of the upper group B are constructed from webs which consist of a nickel-based alloy, in particular Inconel. While achieving the same mechanical stability, this makes it possible to reduce the wall thickness of the webs, and thereby reduces the pressure loss which occurs at each of the spacers. In principle, it is also possible to provide, in the upper group, for two adjacent spacers to be of identical construction, but the flow resistance of the uppermost spacer is always lower than the flow resistance of the lowermost of the upper spacers, in order to counteract the increase in the pressure drop.

1. A fuel assembly for a boiling water reactor, comprising:
a plurality of spacers spaced apart from one another and disposed along an axial direction of the fuel assembly;
a plurality of fuel rods mounted in said spacers, said fuel rods including at least one part-length fuel rod;
diverter elements disposed at least in an upper region of the fuel assembly; and
means for reducing a pressure loss caused by said diverter elements in the upper region.

2. The fuel assembly according to claim 1, wherein at least one of said spacers in the upper region consists of a nickel-base alloy.

3. The fuel assembly according to claim 1, wherein each of said spacers in the upper region is provided with a plurality of said diverter elements, and wherein a number of said diverter elements of an uppermost spacer in the upper region is smaller than a number of said diverter elements of a lowermost spacer in the upper region.

4. The fuel assembly according to claim 3, wherein the number of said diverter elements disposed at a respective said spacer decreases in an upward direction.

5. The fuel assembly according to claim 1, wherein each of said spacers in the upper region is provided with a number of diverter elements, and wherein a sum of surface areas of all said diverter elements, projected onto a plane perpendicular to the axial direction, is smaller for an uppermost spacer in the upper region than the surface area of said diverter elements of a lowermost spacer in the upper region.

6. The fuel assembly according to claim 5, wherein the sum of the surface areas, projected onto the plane perpendicular to the axial direction, of said diverter elements at said spacers in the upper region decreases in an upward direction.
